(19) United States
(12) Patent Application Publication
(10) Pub. No.: US 2008/0296815 A1
(43) Pub. Date: Dec. 4, 2008

(54) Pressure Medium Connector Unit for a Vehicle Gas Spring

(76) Inventors: Olav Borgmeier, Huckeswagen (DE); Eberhard Kaiser, Marienheide (DE); Reiner Mitterer, Wipperfurth (DE); Norbert Terlau, Kurten (DE); Frank Peters, Lindlar (DE)

Correspondence Address: BRINKS HOFER GILSON & LIONE, P.O. BOX 10395, CHICAGO, IL, 60610, US

(21) Appl. No.: 11/994,680

(22) PCT Filed: Jul. 3, 2006
(86) PCT No.: PCT/EP2006/063796

§ 371 Date: May 28, 2008

(30) Foreign Application Priority Data
Jul. 4, 2005 (DE) 20 2005 010 598.8

(51) Int. Cl. F16F 9/02; B60G 11/28

(52) U.S. Cl. 267/64.28

(57) ABSTRACT

In at least one embodiment of the present invention a connector unit for a pressure medium connection between an outer connection part and a spring head of a vehicle gas spring is provided. The connector unit comprises a line configured to be connected to an inner connection part and the outer connection part and is elastically deformable in at least regions during relative rotation movement of the spring head. The line has a deformation section between an end-side line section and an outer line section. The deformable section is disposed in a region of the spring head which is offset to the spring axis and is of helical configuration.

### CROSS REFERENCE TO RELATED APPLICATIONS

This application claims priority to PCT patent application WO 2007/003622, filed Jul. 3, 2006 and DE patent application 20 2005 010 598.8, filed Jul. 4, 2004.

### FIELD OF THE INVENTION

The present invention relates to a connector unit for a pressure medium connection between an outer connection part for mounting on a fixed body part in a stationary manner and a spring head of a vehicle gas spring.

### BACKGROUND OF THE INVENTION

DE 199 22 798 A1 or the corresponding EP 1 053 895 A2 describes a gas spring having a pressure line which is connected to an inlet opening of a spring head (spring pot). In order to make relative rotational movements of the spring part possible here which occur on account of steering movements of the vehicle, there is a provision in the gas spring for the pressure line to extend in the form of a loop with regard to the spring axis. In concrete terms, the loop extends concentrically in a circular manner around the spring axis. As a result the pressure line can be deformed elastically in the manner of a clock spring in the case of the rotational movements of the spring pot.

In practice, there are many applications which are very space constricted and often also are not rotationally symmetrical in the area of the spring head of gas springs such that a large rotationally symmetrical line loop cannot be accommodated.

### SUMMARY OF THE INVENTION

The present invention is based on the object of providing a connector unit of the abovementioned type which, as a result of the compact design, is suitable, in particular, for critical spatial conditions and is highly flexible and robust.

According to the invention, this object may be achieved by the features of each independent claim. Advantageous embodiment features may be contained in the dependent claims.

Accordingly, in the case of an embodiment having a line which can be deformed elastically at least in regions of the relative rotational movements of the spring head, a first embodiment includes that the line has a deformation section between an inner end-side line section which is assigned to the inner connection part and a radially outer line section which is to be fixed in a stationary manner, which deformation section is to be arranged, preferably completely, in a region of the spring head which is offset eccentrically radially with respect to the spring axis. The deformation section may be of a helical configuration with at least one helix axis which is oriented independently of the profile of the spring axis. For example, the helix axis of the deformation section can be oriented transversely, in particular, approximately at right angles or obliquely with respect to the spring axis. Furthermore, the helix axis can also extend offset approximately in parallel with respect to the spring axis. In a further embodiment, the deformation section of the line can also be of double helical configuration in such a way that it has two different helix axes which extend, in particular, approximately at right angles to one another. Here, the profile of the helix axes relative to the spring axis is as desired. As a result, the respective spatial conditions can therefore be utilized in an optimum manner such that the deformation section can also be accommodated in the case of nonsymmetrical spatial conditions. Here, it can additionally be achieved that the line is accommodated without contact and friction, as a result of which the insusceptibility to disruptions or robustness may be achieved. To this end, it is preferable if the deformation section comprises bent helix regions which are always spaced apart from one another without contact and friction.

In another embodiment of the present invention, the inner connection-part may be connected to the spring head in a pivotably movable manner about a pivoting axis which is oriented approximately in accordance with the spring axis. Accordingly, the connection part forms what is known as a swivel which is connected rotatably to the spring head via suitable means for sealing in a pressurized manner. If the pivoting axis coincides at least approximately with the spring axis here, the line can also even be of rigid, substantially nondeformable configuration, for example with a rectilinear profile which is approximately radial with respect to the spring axis. This results in a particularly compact and space-saving design.

### BRIEF DESCRIPTION OF THE DRAWINGS

The invention will be explained in greater detail using a plurality of preferred exemplary embodiments which are illustrated by way of example in the drawings. The drawings are as follows:

FIG. 1 is a diagrammatic, partially axially sectioned side view of a gas spring having a first embodiment of a pressure medium connector unit according to the invention;

FIG. 2 is a view of the region of a spring head in the arrow direction II according to FIG. 1;

FIG. 3 is a plan view in the arrow direction III according to FIG. 2;

FIG. 4 is a separate view of only one line according to FIG. 2;

FIG. 5 is a view of the line according to FIG. 3;

FIG. 6 is a second embodiment of the connector unit in an analogous illustration to FIG. 2;

FIG. 7 is a plan view in the arrow direction VII according to FIG. 6;

FIG. 8 is a separate view of the line according to FIG. 6;

FIG. 9 is a view of the line according to FIG. 7;

FIG. 10 is a third embodiment of the connector unit according to the invention in an illustration as depicted in FIGS. 2 and/or 6;

FIG. 11 is a view in the arrow direction XI according to FIG. 10;

FIG. 12 is a plan view in the arrow direction XII according to FIG. 10;

FIG. 13 is a three view illustration of the separate line according to FIGS. 10 to 12;

FIG. 14 is an embodiment variant to FIG. 10;

FIG. 15 is a side view in the arrow direction XV according to FIG. 14;

FIG. 16 is a plan view in the arrow direction XVI according to FIG. 15;

FIG. 17 is a further embodiment of the invention in an analogous illustration to FIG. 2;

FIG. 18 is a plan view in the arrow direction XVIII according to FIG. 17;

FIG. 19 is a side view in the arrow direction XIX according to FIG. 17;

FIG. 20 is separate views of the line according to FIGS. 17 and 18;

FIG. 21 is a further diagrammatic axial sectional illustration of the region of the spring head with a further embodiment of the connector unit according to the invention;

FIG. 22 is a further embodiment, analogously to FIG. 2;

FIG. 23 is a plan view in the arrow direction XXIII according to FIG. 22;

FIG. 24 is another variant to FIG. 22;

FIG. 25 is a plan view in the arrow direction XXV according to FIG. 24;

FIG. 26 is a final embodiment variant, analogously to FIGS. 22 and/or 24:

FIG. 27 is a side view in the arrow direction XXVII according to FIG. 26i

FIG. 28 is a plan view in the arrow direction XXVIII according to FIG. 27;

FIG. 29 is a plan view in the spring axis direction of an embodiment having an additional covering cap;

FIG. 30 is a side view in the arrow direction XXX according to FIGS. 29 and 31;

FIG. 31 is a partial section in the plane A-A according to FIG. 30;

FIG. 32 is a view as in FIG. 31, but in an embodiment variant;

FIG. 33 is a further alternative to FIGS. 31 and 32; and

FIG. 34 is a cross section in the plane B-B according to FIG. 33.

Identical or functionally corresponding parts and components are always provided with the same designations in the various figures of the drawing.

### DETAILED DESCRIPTION

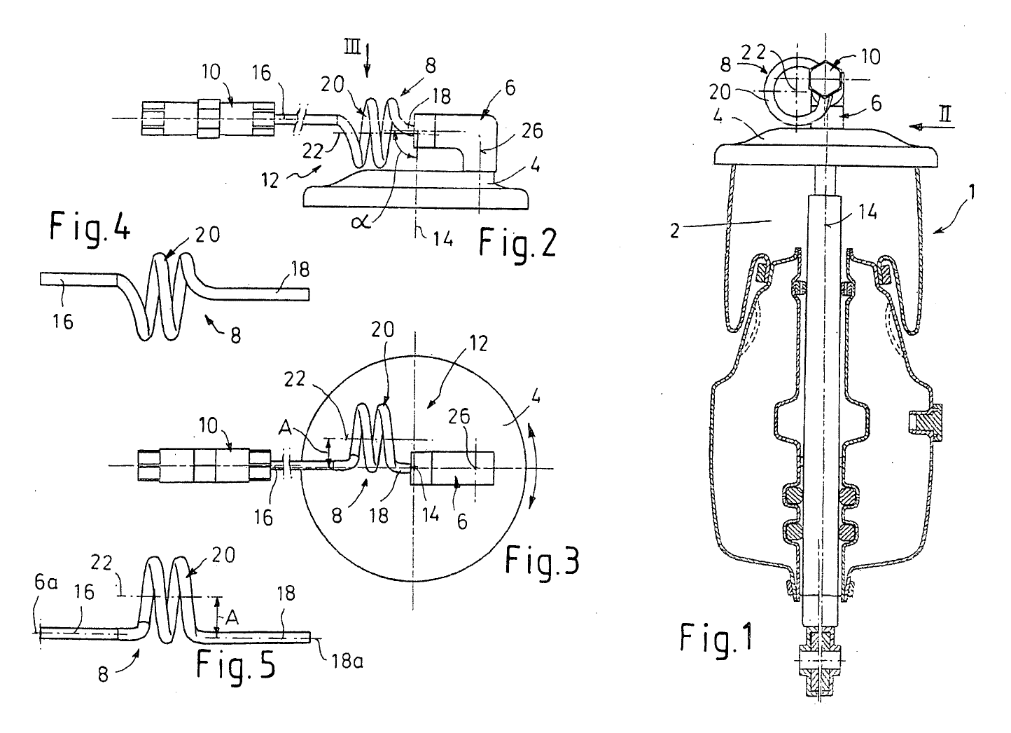

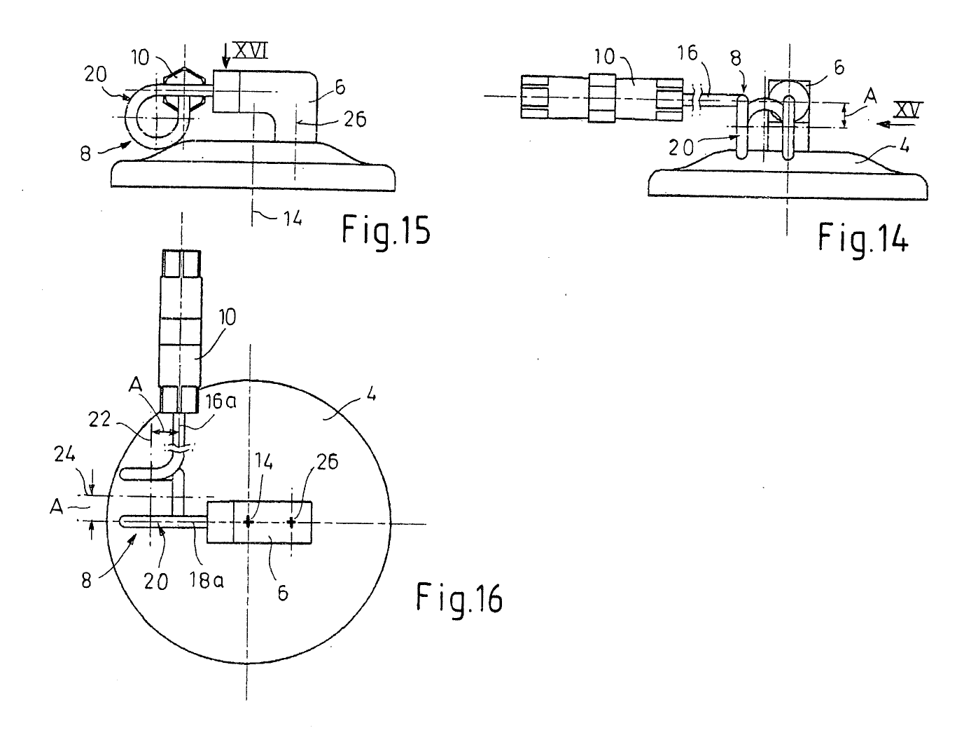

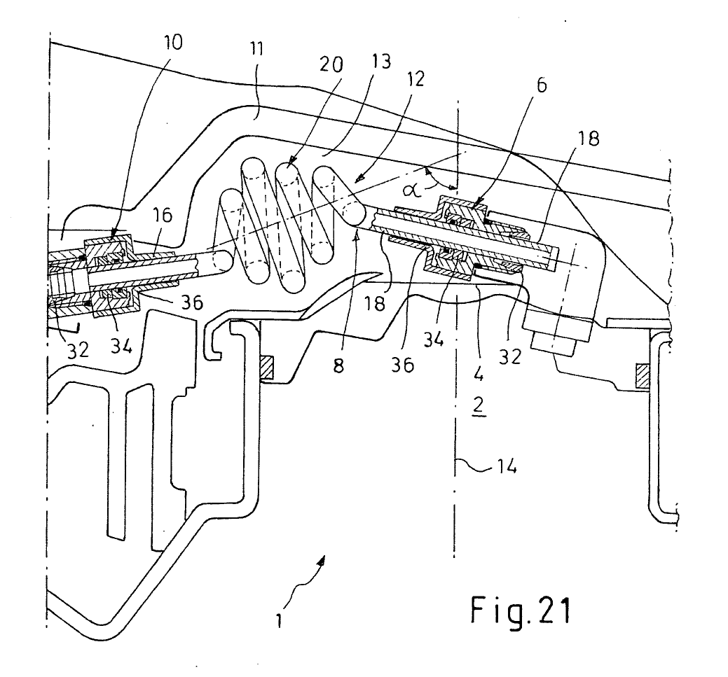

Referring to FIGS. 1 and 21, a vehicle gas spring 1 which has a spring chamber 2 which is filled with an elastically compressible pressure medium such as gas, air or other suitable medium is provided. In the upper region, the spring chamber 2 is delimited by a cover-like spring head 4. In order to connect the spring chamber 2 to the pressure source (not shown here), an inner connection part 6 is arranged in the region of an opening of the spring head 4, which inner connection part 6 is to be connected via a pressure medium line 8, such as for example a pipe or hose, to an outer connection part 10 which is to be mounted on a fixed vehicle part in a stationary manner. The line 8 forms a connector unit 12 at least together with the inner connection part 6, preferably together with both connection parts 6 and 10 in the embodiments according to FIGS. 1 to 28. However, it is possible for the line 8 to be connected releasably, in particular to be connected in a plug-in manner, as a separate component to the connection parts 6 and 10. According to FIG. 21, a receiving space 13 for the connector unit 12 is formed between the spring head 4 and a cap-like cover 11 which is arranged above it at an axial spacing. The receiving space 13 may (as can also be seen in FIG. 21) not be rotationally symmetrical with respect to the spring axis 14.

On account of steering movements in the vehicle, relative rotational movements about the spring axis 14 occur in practice over a defined angular range between the spring head 4 on one side and the adjacent stationary parts and therefore also the cover 11 and the outer connection part 10 on the other side. The connector unit 12 therefore may be designed in such a way that it permits these relative rotational movements.

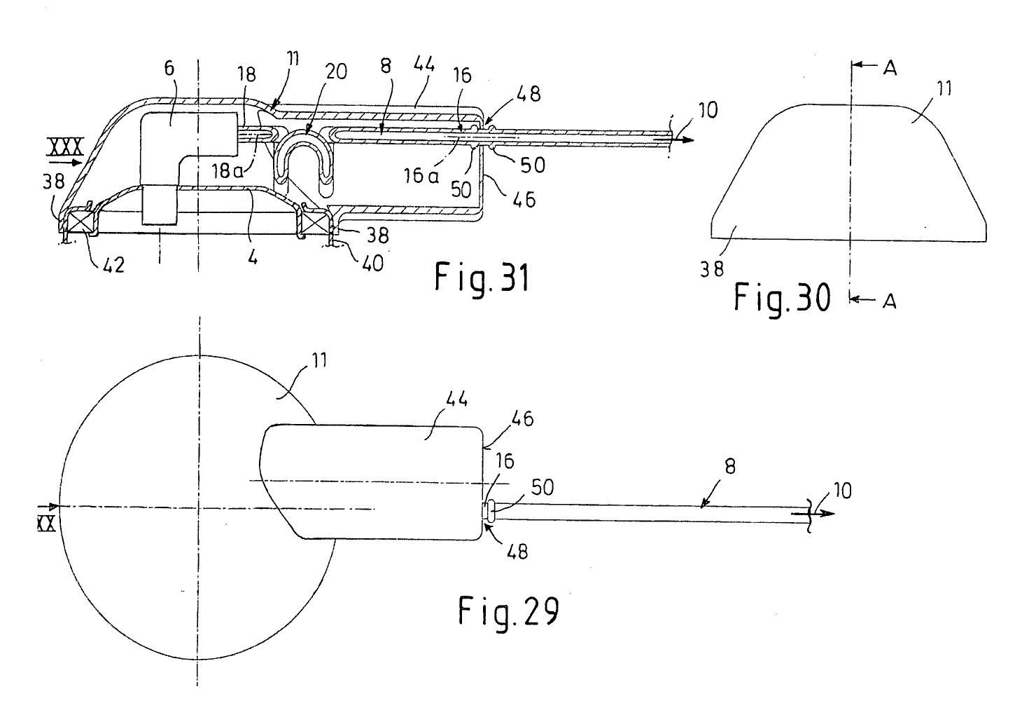

In the embodiments according to FIGS. 1 to 21, 24 to 28 and 29 to 34, the line 8 is configured to be elastically deformable at least in regions, and preferably in a region which is arranged between an outer line section 16 which is to be fixed in a stationary manner in an outer surrounding region of the spring head 4 such as on the cover 11, and an inner end-side line section 18 which is to be connected to the inner connection part 6. Here, the outer connection part 10 can be fixed in the region of the cover 11 (cf. FIG. 21). Alternatively, it can be arranged at another point within the vehicle which can optionally be spaced a distance away (for example, up to 5 m). This later example is intended to be indicated in FIGS. 29 to 33 by a greater length of the line 8 in the direction of the connection part 10 (not shown).

Referring to FIGS. 2 through 5, the line 8 may have a specially shaped deformation section 20 according to the invention between the expediently rectilinear line sections 16 and 18. The specially shaped deformation section 20 is preferably arranged completely in the region of the spring head 4 which is offset eccentrically radially with respect to the spring axis 14, in the mounted state. This means that the spring axis 14 is not tangent on or does not intersect the region of the deformation section 20. Furthermore, according to the invention, the deformation section 20 may be of a helical configuration with at least one helix axis 22 which may be oriented independently of the profile of the spring axis 14.

In the embodiments according to FIGS. 1 to 5, the helix axis 22 is oriented transversely, in particular approximately at right angles with respect to the spring axis 14 or with respect to a radial plane which is defined by the spring axis 14 (see FIG. 3 and the angle α in FIG. 2). According to FIG. 3, the helix axis 22 may not intersect the spring axis 14, but may lay offset parallel with respect to a radial plane.

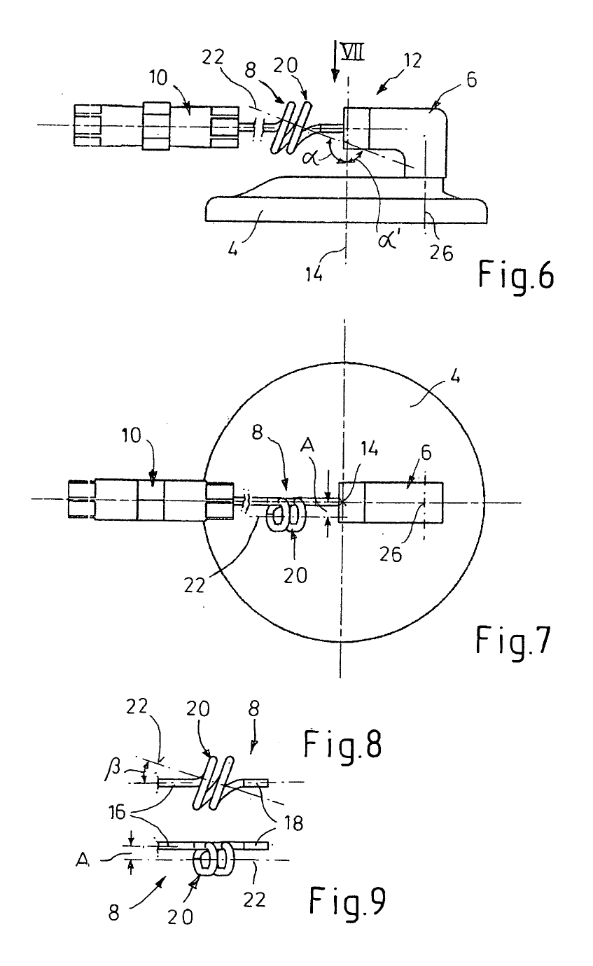

In the embodiments according to FIGS. 6 to 9 and 21, the helix axis 22 is oriented obliquely at an angle α which is not equal to 90° with respect to the spring axis 14. Here, the angle α (FIG. 21) or its supplementary angle α′ (FIG. 6) can lie in a range from 5° to 85°, preferably approximately in the range from 35° to 55′ Here too, the helix axis 22 preferably extends offset parallel with respect to the radial plane, with the result that it does not intersect the spring axis 14 (FIG. 7).

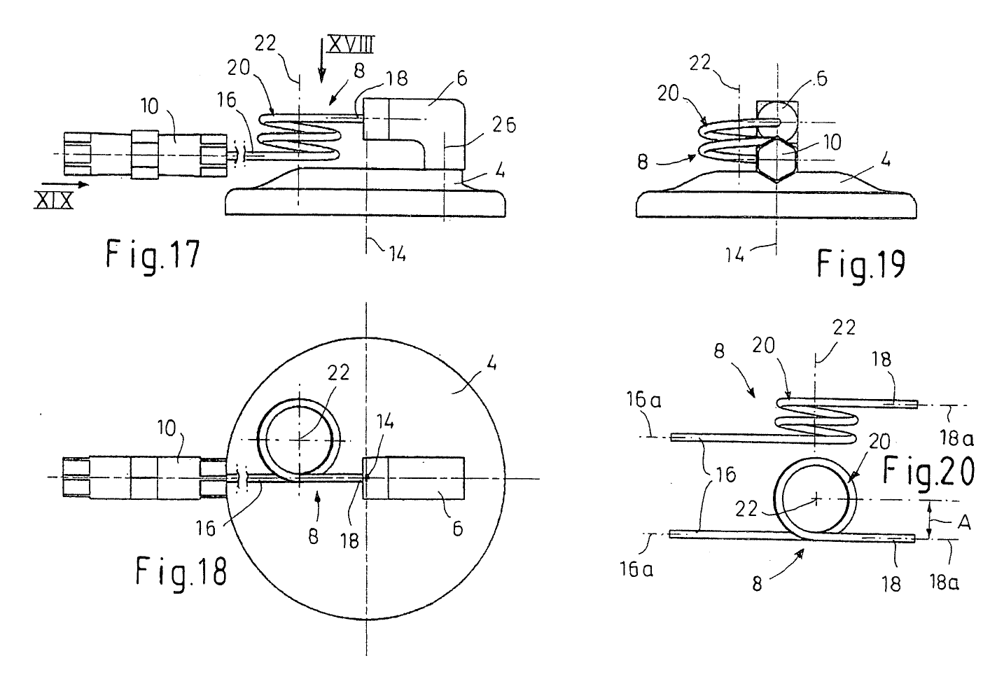

In the embodiment according to FIGS. 17 to 20, the helix axis 22 likewise extends independently of the spring axis 14, and is preferably approximately offset parallel with respect to the spring axis 14.

In the abovementioned embodiments according to FIGS. 1 to 5 and 17 to 20, the deformation section 20 comprises, for example, two complete helix turns with a circular profile. The helixes may be spaced axially apart from one another without friction. In the embodiment according to FIGS. 6 to 9, the helixes may be configured with an approximately oval profile. According to FIG. 21, a spiral helix can also be provided. The helixes may extend with a continuously increasing radius, starting from the outer line section 16, as far as approximately half of the deformation section and then extending with a radius which decreases again as far as the inner line section 18. As a variant to FIG. 21, a spiral helix can also be provided which extends from one line section 16 (or 18) with a continuously increasing helix radius as far as the end of the deformation section 20 or as far as the other line section 18 (or 16).

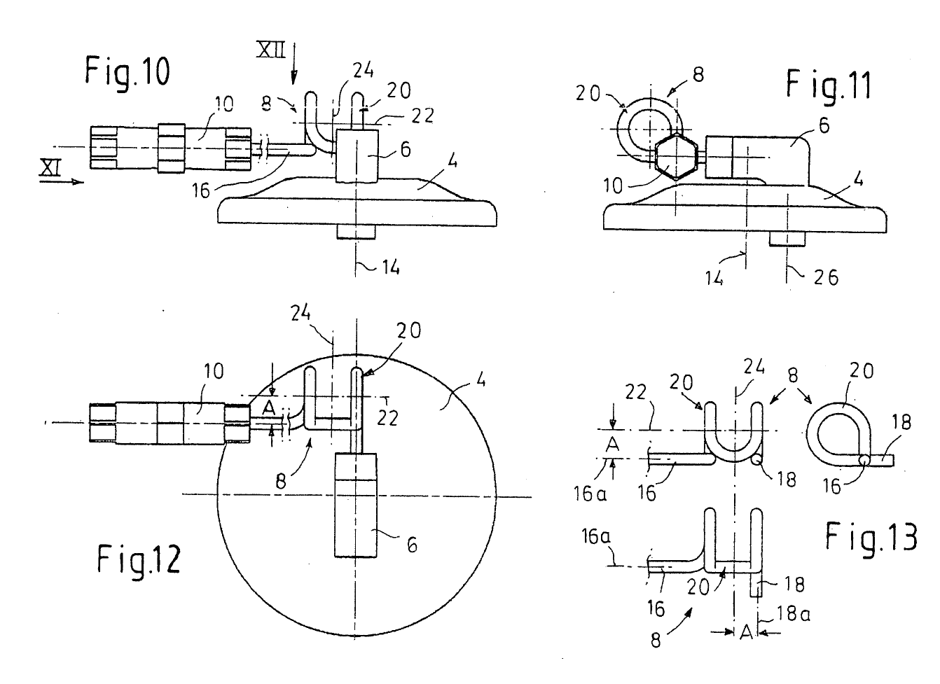

In the embodiments according to FIGS. 10 to 13 and 15 to 16, the deformation section 20 of the line 8 may be at least a double helical configuration in such a way that it has at least two different helix axes (or deformation axes) 22 and 24 which, in particular, extend approximately at right angles to one another. In the example which is shown, the profile contour of the deformation section 20 encloses approximately a spherical hollow space. This configuration of the deformation section 20 can also be called a spherical helix.

In all the embodiments, the deformation section 20 comprises bent helix regions which are spaced apart from one another without contact and friction. As a result, a robust and satisfactory service life may be achieved by friction-induced damage in the line 8 being avoided.

The preferably rectilinear line sections 16 and 18 in each case define, as a result of their longitudinal extent, a longitudinal axis 16a and 18a which, for a rectilinear, direct, substantially radial connection according to FIGS. 1 to 9 and 17 to 20, lay approximately on a common, continuous axis. As an alternative, according to FIGS. 10 to 16 and 21, there may be an angular connection for the longitudinal axes 16a and 18a to enclose a defined angle of, for example, 90° between them. As results further, for example, from FIG. 5, the longitudinal axes 16a and 18a are offset parallel with respect to the helix axis 22 (spacing A). As an alternative, however, the line sections 16 and 18 can also extend coaxially with respect to the respective helix (longitudinal axis 16a or 18a coincides with the helix axis 22), in order to achieve a uniform (symmetrical) deformability of the deformation section 20. In the embodiment according to FIGS. 6 to 9, the oblique profile of the helix axis 22 (FIG. 6) also results in a corresponding angle β between the helix axis 22 and the longitudinal axes 16a and 18a (FIG. 8).

In the above-described embodiments, the line 8 preferably comprises a smooth-walled plastic pipe made from an elastomer. In one example, the line 8 is made from polyamide (PA), such as for example PA6, 6. Here, the deformation section 20 is permanently (plastically) preshaped (bent in a shaped manner). As an alternative, what is known as a corrugated pipe which is preferably made from PA can also be used at least in sections or any desired hose. In addition, the line 8 can also be a layer or layered construction of the wall with elastomers (PA) and/or TPE layers (TPE= thermoplastic elastomer).

Furthermore, in all of the above-described embodiments according to FIGS. 1 to 21, the inner connection part 6 can be connected rigidly to the spring head 4, such as for example by being screwed or soldered. As an alternative to this, it can be advantageous to connect the inner connection part 6 to the spring head 4 in a pivotably movable manner about a pivoting axis 26 which is oriented approximately in accordance with the spring axis 14 and is preferably offset in parallel. To this end, a pivoting bearing is provided with suitable means for sealing in a pressurized manner.

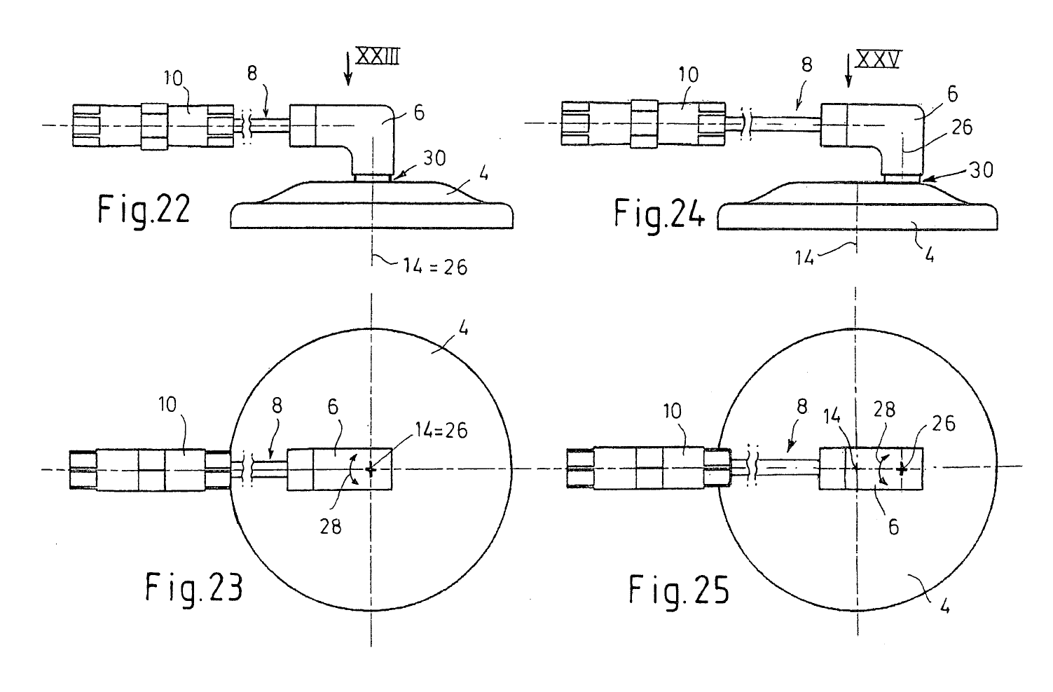

As far as the embodiments according to FIGS. 22 to 28 are concerned, an ability for the inner connection part 6 to move pivotably in this way relative to the spring head 4 about the pivoting axis 26 is necessarily provided according to the invention here. As a consequence, the connection part 6 forms what is known as a swivel. The ability to move pivotably is indicated in FIGS. 23, 25 and 28 in each case by a double arrow 28. The connection is effected via a suitable pivoting bearing 30 with means (which cannot be seen) for sealing in a pressurized manner (in the manner of a shaft seal).

In the embodiment according to FIGS. 22 and 23, the pivoting axis 26 coincides at least approximately with the spring axis 14. As a result, in the case of rotational movements of the spring head 4, the connection part 6 remains at a standstill in a stationary manner with the result that the line 8 can be of relatively rigid and dimensionally stable configuration with a rectilinear profile which is approximately radial with respect to the spring axis 14. The line 8 can therefore be made of any desired material, apart from plastic but even of metal, for example steel. This can achieve a very short, direct, radial connection of the connection parts 6 and 10.

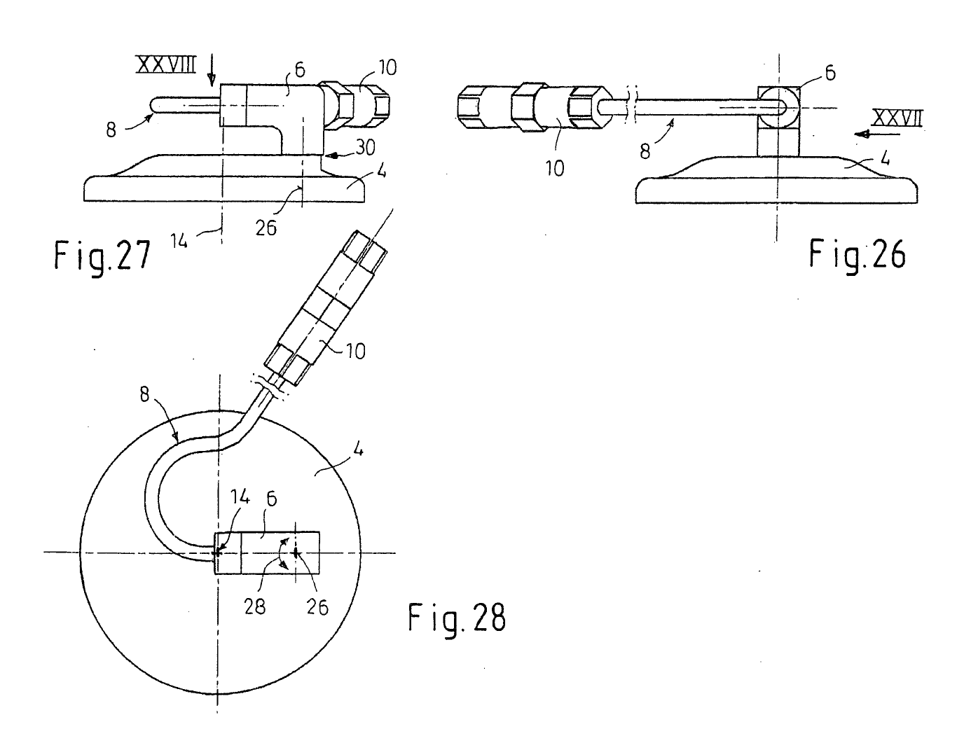

In the embodiments according to FIGS. 24 to 28, the pivoting axis 26 may be offset parallel relative to the spring axis 14, and preferably to the side of the spring head 4 which lies spaced apart from the outer connection part 10 or lies opposite the line outlet side. As a result, relative movements of the spring head 4 also bring about certain rotational movements of the connection part 6 on a circular path because it is driven in the region of the pivoting axis 26. Here, the line 8 is therefore configured such that it can bend elastically into itself by either a rectilinear profile which is approximately radial with respect to the spring axis 14 (FIGS. 24, 25) or with a slightly arcuate profile (FIGS. 26 to 28). This can be ensured with a-smooth-walled plastic pipe, a corrugated pipe or a hose.

In all the embodiments which are shown in FIGS. 1 to 34, the connection parts 6 and 10 are preferably configured for the simple plugged connection of the line ends. At least the inner connection part 6 forms an angular connector, the connection of the line 8 being oriented transversely (perpendicularly) with respect to the direction of the spring axis 14 and the connection to the gas spring 2 being oriented approximately axially parallel with respect to the spring axis 14. With respect to the line connection, reference is made to FIG. 21, according to which a conical clamping ring 32 and at least one circumferential seal 34 may be arranged within each connection part 6 and 10. In addition, in one embodiment, at least the inner connection part 6 is equipped with a sleeve-shaped supporting element 36 which supports the line 8 against transverse movements in the region of the inner line section 18 which is arranged ahead of the connection part 6 (torque support). The outer line section 16 is also preferably fixed in a stationary manner, for example by means of a line clip on a stationary spring strut dome or on/in the cap-like cover 11.

In this respect, reference is made to the exemplary embodiments according to FIGS. 29 to 34 which, with regard to the deformation section 20 of the line 8, correspond substantially to FIGS. 10 to 16, but with the difference that the longitudinal axes 16a and 18a of the line sections 16 and 18 are oriented such that they are aligned approximately with the same axis. However, the alternative with longitudinal axes 16a and 18a which are oriented at an angle with respect to one another, in an analogous manner to FIGS. 10 to 16, is also possible here.

As results from FIGS. 29 to 34, the cap-shaped cover 11 can be fastened in a stationary manner by way of a circumferential edge 38 on the spring strut dome 40 (indicated only diagrammatically). The spring head 4 is guided rotatably relative to the spring strut dome 40 via a rotary bearing 42. The cover 11 has an approximately radial projection 44 having an end-side wall 46, in the region of which a leadthrough 48 is formed for the line 8 or for its outer line section 16. The line section 16 is fixed in the leadthrough 48 against longitudinal movements and preferably also against rotational movements about the line longitudinal axis 16a.

In the embodiment according to FIGS. 29 to 31, the line 8 has two outer annular bead projections 50 which are spaced apart axially and are upset by a forming technique, for example, between which the wall 46 of the cover 11 is seated in such a way that the line 8 or its line section 16 is fixed axially. For assembly/dismantling, the cover 11 can be pushed over the respective annular bead projection 50 with elastic deformation in the region of the leadthrough 48.

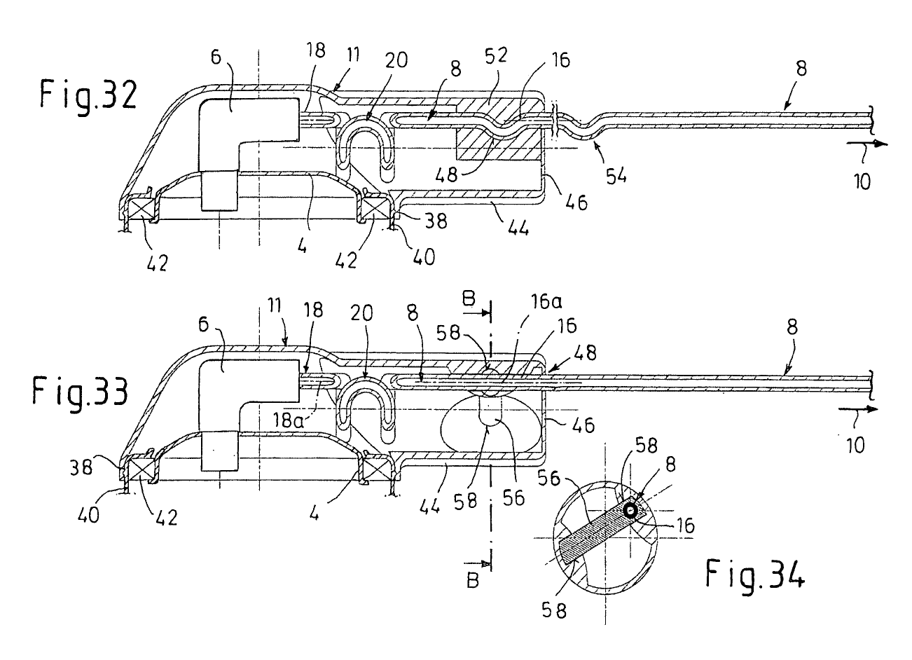

in the embodiment according to FIG. 32, the leadthrough 48 is configured as a channel with a relatively large axial length within a thickened wall region 52 and with a nonlinear profile which is, for example, arcuate or corrugated as shown. Here, in the region of the line section 16, the line 8 has a profile which is adapted to the profile of the leadthrough 48 in such a way that, in the mounted state (see FIG. 32), relative fixing is achieved against movement in the longitudinal direction and also against rotation about the longitudinal axis. Here, in a region which lies outside the cover 11 and spaced apart from the line section 16, the line 8 can have a further section 54 which corresponds to the line section 16 and makes fixing of the cover 11 possible on the line 8 in a preassembly position. A displacement of the cover 11 on the line 8 is possible in each case with elastic deformation of the cover 11 and/or of the line 8, in particular, however, of the line 8 in the region of the sections 16 and 52, as a result of which a latching action is achieved.

Finally, in the embodiment according to FIGS. 33 and 34, there is provision for the line 8 to be connected fixedly, in particular with a material-to-material fit to a transverse pin 56 in the region of the line section 16, which transverse pin 56 is held within the cover 11 or the projection 44 in receptacles 58 (see FIG. 34) by way of its ends. The assembly/dismantling is possible in each case with elastic (oval) deformation of the cover 11 in the region of the projection 44. This embodiment also brings about double fixing of the line 8 in the region of the line section 16 in the longitudinal and rotational directions.

The cover 11 should be of soft and flexible configuration at least in regions (accident protection) and can be composed of plastic as a multiple component shaped part (2K molded part).

As a person skilled in the art will appreciate, the above description is meant as an illustration of implementation of the principles of this invention. This description is not intended to limit the scope or application of this invention in that the invention is susceptible to modification, variation, and change, without departing from the spirit of this invention, as defined in the following claims.

1. A connector unit for a pressure medium connection between an outer connection part which is for mounting in a stationary manner and a spring head of a vehicle gas spring, the spring head is adapted to be rotated relative to the outer connection part about a spring axis over a defined angular range, the vehicle gas spring having an inner connection part for mounting on the spring head, the connector unit comprising a line configured to be connected to the inner connection part and the outer connection part, and is elastically deformable at least in regions during relative rotational movements of the spring head, wherein the line has a deformation section between an end-side line section which corresponds to the inner connection part and an outer line section which is for fixing in a stationary manner, the deformation section is disposed in a region of the spring head which is offset eccentrically radially to the spring axis and is of helical configuration with at least one helix axis which is oriented independently of the spring axis.

2. The connector unit according to claim 1, wherein the helix axis of the deformation section is oriented one of transversely and obliquely to the spring axis.

3. The connector unit according to claim 1, wherein the helix axis extends offset approximately in parallel with respect to the spring axis.

4. The connector unit according to claim 1, wherein the deformation section of the line is of at least double helical configuration such that at least a second helix axis extends approximately at a right angle to the helix axis.

5. The connector unit according to claim 1, wherein the deformation section comprises a plurality of bent helix regions which are spaced apart such that the bent helix regions do not create friction by moving relative to each other.

6. The connector unit according to claim 1, wherein the outer line section and the end-side line section of the line each case define a corresponding longitudinal axis extending at one of approximately the same axis and at an angle to one another.

7. The connecting unit according to claim 1, wherein the inner connection part is connected rigidly to the spring head.

8. The connector unit according to claim 1, wherein the inner connection part is connected to the spring head in a pivotably movable manner about a pivoting axis which is positioned approximately parallel with the spring axis.

9. A connector unit for a pressure medium connection between an outer connection part which is for mounting in a stationary manner and a spring head of a vehicle gas spring, the spring head is adapted to be rotated relative to the outer connection part about a spring axis over a defined angular range, the vehicle gas spring having an inner connection part for mounting on the spring head, the connector unit comprising a line configured to be connected to the inner connection part and the outer connection part, wherein the inner connection part is configured to be connected to the spring head in a pivotably movable manner about a pivoting axis which is positioned approximately parallel with the spring axis.

10. The connector unit according to claim 9, wherein the pivoting axis at least approximately coincides with the spring axis.

11. The connector unit according to claim 10, wherein the line is substantially rigid and dimensionally stable, and is rectilinear and positioned approximately radial to the spring axis.

12. The connector unit according to claim 9, wherein the pivoting axis extends offset in parallel to the spring axis on a side of the spring head which lays spaced apart from one of the outer connection part and a line outlet side.

13. The connector unit according to claim 1, wherein the line is elastically bendable with a rectilinear profile which is approximately radial to one of the spring axis and an arcuate profile.

14. The connector unit according to claim 1, wherein the outer connection part and the inner connection part are configured for plug-in connection to the outer line section and the end-side line section of the line respectively

15. The connector unit as according to claim 1, wherein the line comprises a plastic pipe which is shaped in a bent manner in regions.

16. The connector unit as according to claim 1, wherein the line is plastic and is configured as one of a smooth-walled pipe, as a flexible corrugated pipe and a hose.

17. The connector unit according to claim 1, wherein the outer line section is fixed via a cap-like cover which can be placed in a stationary manner on a spring strut dome.

18. The connector unit according to claim 17, wherein the cover has a wall with a leadthrough for the line, the line being fixed in the leadthrough by its outer line section against longitudinal movements and against rotational movements about a line longitudinal axis.
